(19) United States
(12) Patent Application Publication
(10) Pub. No.: US 2011/0002252 A1
(43) Pub. Date: Jan. 6, 2011

(54) FRAME STRUCTURE FOR PICONET MASTER NODE ON/OFF SCHEDULING AND METHOD THEREOF

(75) Inventors: Eui-Jik KIM, Suwon-si (KR); Jeongsik In, Yongin-si (KR); Yongsuk Park, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/824,645

(22) Filed: Jun. 28, 2010

(30) Foreign Application Priority Data
Jul. 1, 2009 (KR) 10-2009-0059927

(51) Int. Cl. H04W 52/02

(52) U.S. Cl. 370/311

(57) ABSTRACT

A frame structure for piconet master node on/off scheduling and method thereof. The frame structure includes a schedule-based data period, a contention-based active period, a schedule-based schedule notification message period directly following the contention-based active period, and an inactive sleep mode period positioned before the schedule-based data period, before or after the contention-based active period, or after the schedule-based schedule notification message period.

### PRIORITY

This application claims priority under 35 U.S.C. §119(a) to an application filed in the Korean Industrial Property Office on Jul. 1, 2009 and assigned Serial No. 10-2009-0059927, the content of which is hereby incorporated by reference.

### BACKGROUND OF THE INVENTION

1. Field of the Invention

The present invention relates generally to a Wireless Body Area Network (WBAN) in a Wireless Sensor Network (WSN), and more particularly to a “frame structure” for piconet master node on/off scheduling and a method thereof.

2. Description of the Related Art

Piconets are networks used for exchanging information between devices across very small distances. For example, such networks might be used to exchange data from a person's mobile phone to his/her personal digital assistant.

A piconet is composed of a “master node” (e.g. a mobile phone) that serves as a coordinator and a plurality of subservient “slave nodes.” Slave nodes are various kinds of portable devices for individual use, such as an MP3 player, in-body sensor, on-body sensor, and the like.

WBAN is an emerging standard commonly applied to connect a plurality of piconets. Thus, if three people wished to exchange information from their personal piconets, they would do so across a WBAN. FIG. 1 illustrates how such a network might be visualized.

WBAN requires performance constraints similar to those of a sensor network, and in consideration of WBAN applications, it is necessary to consider collision problems due to interference among the plurality of piconets that occur when several persons exist or move in a limited space. Accordingly, the design of a system of unique identification, such as a specified Media Access Control (MAC) protocol is required for an effective WBAN.

Carrier Sense Multiple Access (CSMA) and Time Division Multiple Access (TDMA) may be considered as related art. The competing standards each have their own advantages and perform differently in areas with high node density and areas with low node density, commonly referred to as “high contention” and “low contention” environments.

CSMA does not require time synchronization among nodes, and shows a high rate of channel use and a low delay performance in a low contention environment. However, in a high contention environment in which the number of nodes in the interferential range is increased, collisions and performance deterioration problems, such as unexpected delay, increase or the like occur due to the back-off. As a result, it is difficult to apply CSMA to WBANs where a plurality of piconets exist in a narrow space and real-time responses are required.

TDMA has advantages such as a high channel use rate in a high contention environment, collision reductions, removal of unexpected delay, and the like, but has overhead problems due to the time synchronization. In general, TDMA uses a time synchronization root for the time synchronization, and has disadvantages that a lot of time and energy are consumed for the time synchronization.

Accordingly, in order to complement the disadvantages of the two access methods as described above, a MAC protocol that incorporates both CSMA and TDMA has been researched. The IEEE 802.15 WPAN Task Group 6 has been formed specifically to propose a “distributed TDMA” MAC, which is a CSMA/TDMA convergence-type MAC protocol that supports both node mobility and interference avoidance between piconets.

This proposed distributed TDMA, avoids interference by using a control message exchange even if the time synchronization does not work for each piconet, and thus the communication can occur. FIG. 2 illustrates a typical distributed TDMA transmission.

The reference numerals “201” through “206” denote master nodes of piconets, and “211” through “216” denote data frames. First to third data streams 211, 212, and 213 are data streams which are used in the first group, composed of the first to third nodes 201, 202, and 203. Fourth to sixth data streams 214, 215, and 216 are data streams which are used in the second group, composed of the fourth to sixth nodes 204, 205, and 206.

A “super frame” of each data stream may be divided into a CSMA period and a TDMA period. A time period, which is indicated as the same pattern as a pattern that represents each node on the data stream, represents packet transmission through the corresponding node in the corresponding period. In the CSMA period, packets are irregularly transmitted by a CSMA algorithm, while in the TDMA period, packets are transmitted in a time slot period that is fixed for each node. In the TDMA transmission period, the master node performs scheduling for the respective nodes.

When the transmission times in the TDMA periods overlap each other between neighboring piconets, a control message (also known as a “TDMA schedule advertisement message”) is exchanged between the neighboring master nodes. Through this, the master nodes respectively move to other positions in which the transmission. times do not overlap each other to avoid the interference. The reference numerals “M1” and “M2” indicate the movement of the nodes to avoid the overlapping of the schedules. Thus readjustment of the TDMA transmission schedule is performed without having to unify the time synchronization between competing master nodes.

FIG. 3 illustrates a control message structure of a distributed TDMA and a time offset table structure.

The distributed TDMA uses both advantages of CSMA and TDMA, and has the further advantages of the node mobility, settlement of interference problems between piconets, and the like. However, the distributed TDMA has problems with energy consumption.

In order for the distributed TDMA to operate, a piconet master node should be kept in an active, energy intensive state. In order to receive a control message from a neighboring piconet, a transceiver of a master node is always in an “Rx state.” In the Rx state, the extent of power consumption is similar to a case in which packets are transmitted, and thus it can be expected that the lifespan of the master node's power supply will be very short. If the master node runs out of power, the whole piconet cannot perform the communication.

Also, in the same manner as the existing TDMA method, it is difficult to avoid an initial collision during the access of a new (i.e. non-pre-recognizable) piconet group. The distributed TDMA, if the TDMA periods overlap each other, avoids the collision by rearranging the TDMA periods through the control message exchange. Accordingly, collisions occur when the TDMA periods overlap each other before the rearrangement of the TDMA periods is performed, and thus energy is wasted during the retransmission.

### SUMMARY OF THE INVENTION

The present invention has been made to solve the aforementioned problems found in distributed TDMA by providing an on/off frame scheduling method for the piconet master node.

In accordance with an aspect of the present invention, there is provided a frame structure for piconet master node on/off scheduling, which includes a time division multiple access (TDMA) data period; a contention-based active period; a schedule-based schedule notification message period directly following the contention-based active period; and an inactive sleep mode period positioned before the schedule-based data period, before or after the contention-based active period, or after the schedule-based schedule notification message period.

In accordance with another aspect of the present invention, there is provided a method of transmitting a control message in a current super frame by a piconet master node. The method includes a) determining whether a current channel is busy or idle; b) if the current channel is idle, confirming that the current channel remains idle over a predetermined number of times, and transmitting the control message, when the current channel remains idle over the predetermined number of times; and c) if the current channel is busy or if the current channel does not remain idle for the predetermined number of times, returning to step a).

In accordance with another aspect of the present invention, there is provided a piconet master node on/off scheduling method, which includes waiting for reception of a control message for a predetermined time; updating a time division multiple access (TDMA) time offset table if the control message is received within the predetermined time; and deleting a corresponding entry of the TDMA time offset table if the control message is not received within the predetermined time.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a configuration of WBAN piconets;

FIG. 2 illustrates a configuration of a distributed TDMA;

FIG. 3 illustrates a control message structure of a distributed TDMA and a time offset table structure;

FIG. 4A illustrates a conventional super frame;

FIG. 4B illustrates a super frame according to an embodiment of the present invention;

FIG. 5 illustrates a super frame according to another embodiment of the present invention;

FIG. 6 is a flowchart illustrating a method of transmitting a control message of a master node according to an embodiment of the present invention;

FIG. 7 is a flowchart illustrating a method of receiving a control message of a neighboring piconet according to an embodiment of the present invention; and

FIGS. 8A and 8B illustrate TDMA CCA according to an embodiment of the present invention.

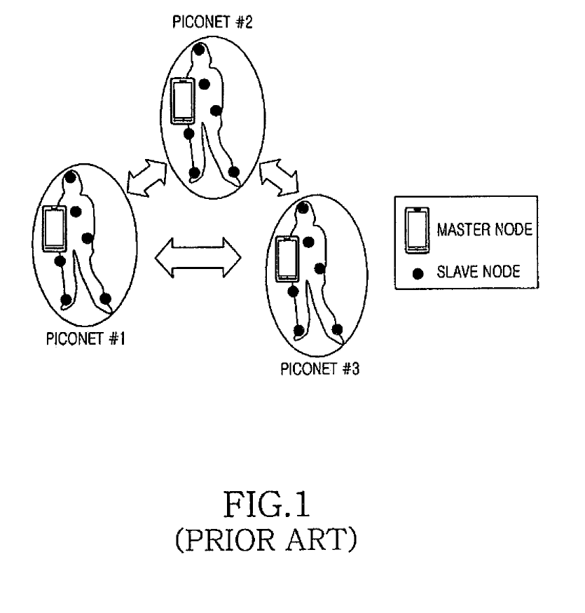

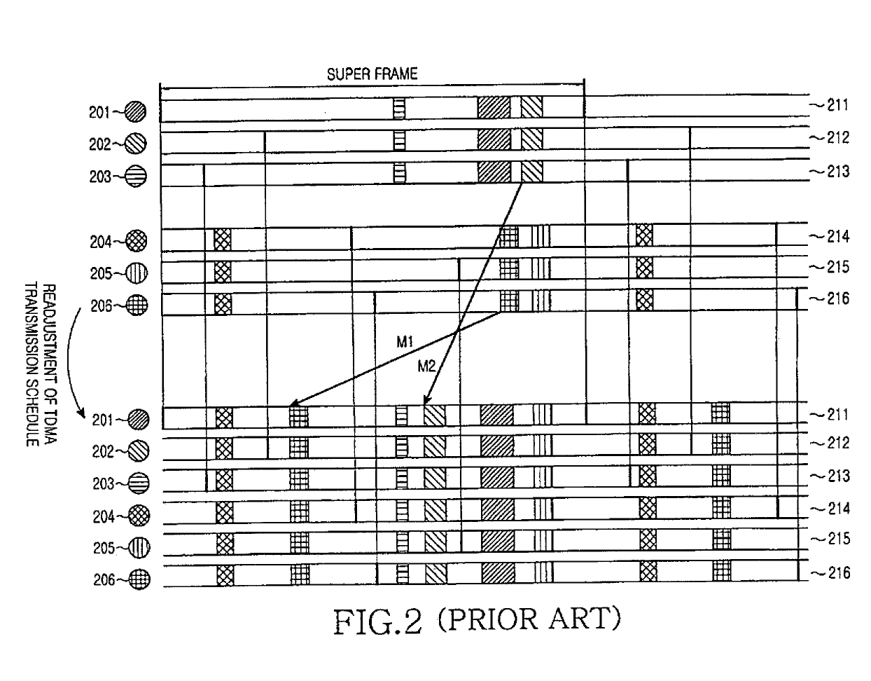

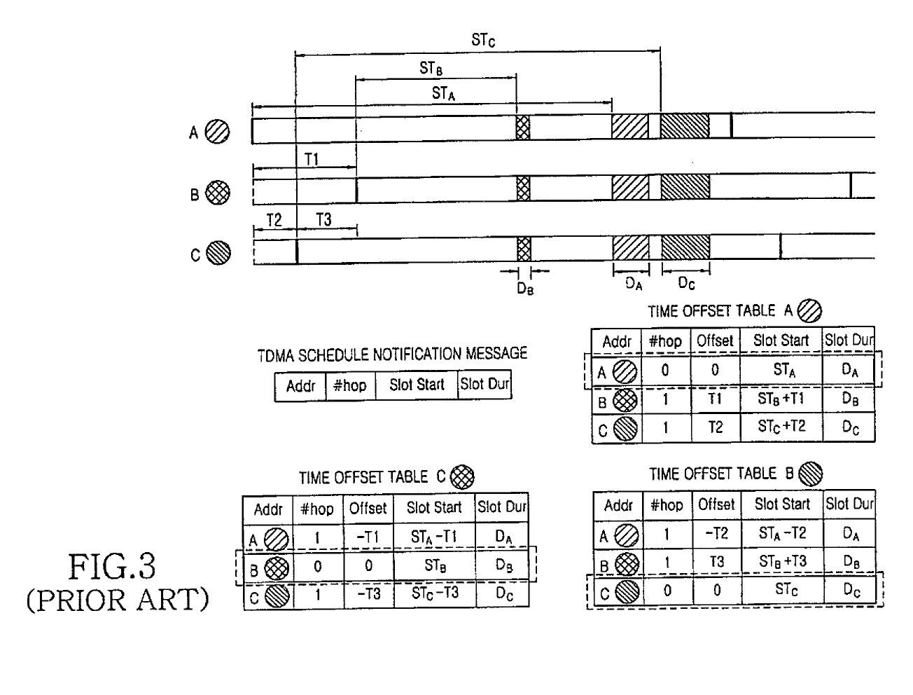

### DETAILED DESCRIPTION OF EMBODIMENTS OF THE INVENTION

Hereinafter, various embodiments of the present invention will be described with reference to the accompanying drawings. In the following description, the same elements will be designated by the same reference numerals although they may be shown in different drawings. Further, various specific definitions found in the following description, such as specific values, the specific number of times, etc., are provided only to help in the general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

In a distributed TDMA, a piconet master node is kept in an active state in order to receive a control message that is transmitted at an arbitrary time. Accordingly, in an embodiment of the present invention, each master node has a frame structure that transmits the control message just after a TDMA period, and thus a neighboring master node can predict a control message transmission time of the opposite party. Accordingly, it is possible to perform an on/off operation for reducing energy consumption. Also, by introducing duty cycling to the CSMA period, it is possible to set a plurality of active periods and inactive periods.

In another embodiment of the present invention, during the access of a new, unrecognizable piconet group, a Clear Channel Assessment (CCA) method in a TDMA period is provided in order to avoid the initial collision. Accordingly, even in a state where a collision could occur, the probability of collision occurrence is minimized, and the occurrence of such a collision may be sensed.

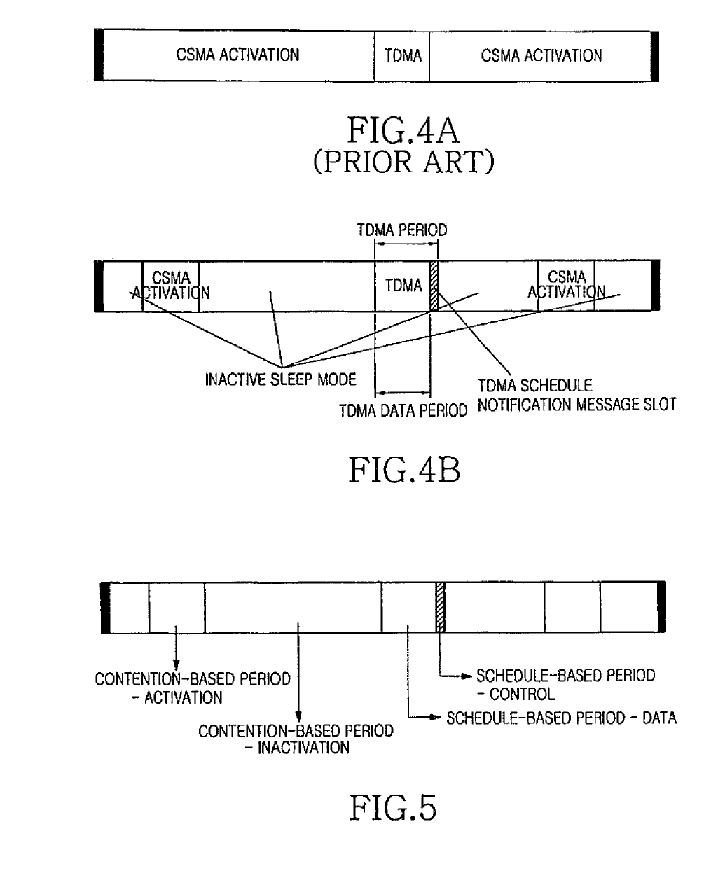

FIG. 4A illustrates a conventional super frame, and FIG. 4B illustrates a super frame according to an embodiment of the present invention.

The super frame structure as illustrated in FIG. 4A is for a distributed TDMA, i.e. for MAC in which a contention method and a scheduled method are combined.

The super frame includes one TDMA period and one or more CSMA active periods. A period that lacks both a TDMA period and CSMA period is an inactive period, which corresponds to a sleep mode for preventing unnecessary energy consumption.

A control message transmission slot (i.e. TDMA schedule notification message slot) is positioned at an end portion of the TDMA period. Because the control message transmission slot is also included in the TDMA period, the control message is transmitted in a TDMA mode. In accordance with the above-described structure, the master node can predict the control message transmission time from a neighboring piconet. That is, the master node receives the control message through the prediction of a TDMA transmission period (i.e. schedule-based period) schedule, and can perform an on/off operation, which can reduce the waste of energy.

The periods in which a transceiver of a master node operates in an active state is its own TDMA transmission period (including a control message transmission slot), the control message transmission slot of a neighboring master node, and its own CSMA active period.

FIG. 5 illustrates super frame according to another preferred embodiment of the present invention.

The various embodiments of the present invention will be described using a distributed TDMA by way of example. However, the present invention can also be applied to any other MAC that is similar to the distributed TDMA, i.e. a MAC in which a contention-based MAC such as CSMA and a schedule-based MAC such as TDMA are combined. Accordingly, in the contention-based period, a modified CSMA type technology may be used, and in the schedule-based period, another technology such as polling may be used.

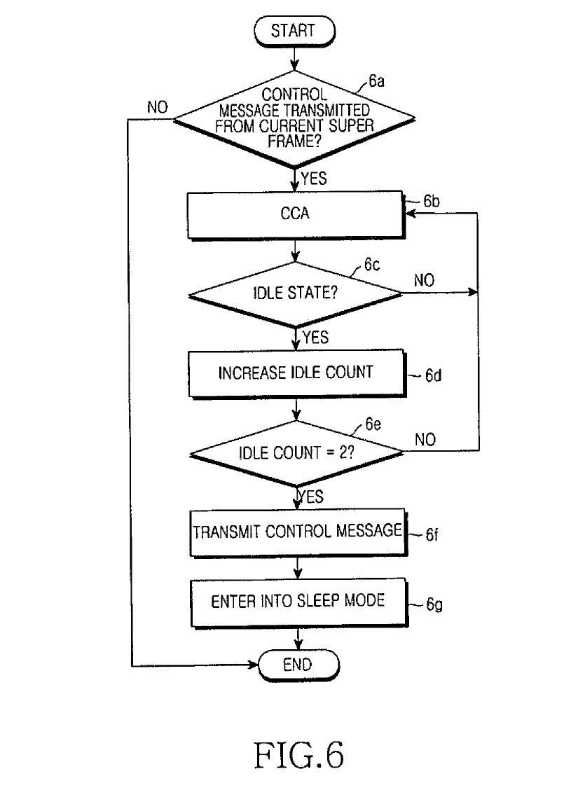

FIG. 6 is a flowchart illustrating a method of transmitting a control message by a master node according to an embodiment of the present invention.

In a distributed TDMA, interference avoidance comes at the expense of additional overhead in control message exchange. If TDMA transmission period schedules between neighboring piconets overlap each other, a master node rearranges the TDMA periods based on the control message of an opposite party to avoid the collision. However, the act of transmitting a control message that includes a time offset table for each period increases transmission overhead and negatively affects network performance. In consideration of such a tradeoff an embodiment of the present invention includes a control message, which is transmitted in the period of one or more super frames.

Specifically, when the data transmission is completed in the TDMA transmission period, the master node determines whether to transmit a control message in the current super frame in step 6a. If the master node determines to transmit the control signal in the current super frame, CCA is performed twice through steps 6b to 6e.

The CCA in step 6b is employed to confirm whether the current channel is busy through carrier sensing, to confirm the transmission state of the neighboring piconet and to prevent message collision. In step 6c, the master node checks whether the channel is in an idle state. If it is, an idle count variable is increased in step 6d, and the master node confirms whether the idle count value is equal to 2 in step 6e. This confirms whether the CCA has been performed twice. If the idle count value is 2, the CCA has been performed twice, and thus a control message is transmitted in step 6f. Then, the master node enters into a sleep mode in step 6g.

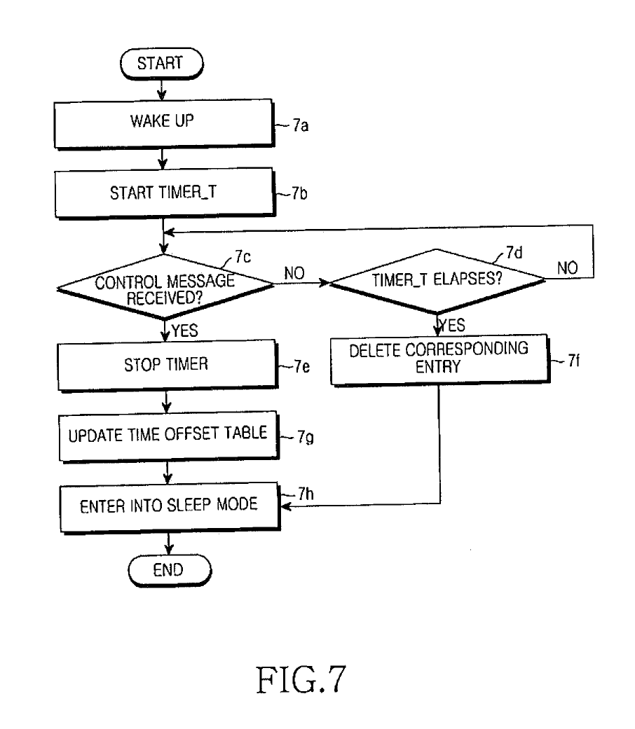

FIG. 7 is a flowchart illustrating a method of receiving a control message of a neighboring piconet according to an embodiment of the present invention.

A master node, which has woken up in step 7a, waits for a control message for a time, T, at a time point for data transmission in a TDMA period of a neighboring piconet in step 7b. Timer_T corresponds to this offset value.

If the master node receives the control message in step 7c before Timer_T elapses, it ends Timer_T in step 7e, updates the TDMA time offset table in step 7g, and then enters into a sleep mode in step 7h.

By contrast, if the master node has not received the control message before Time_T elapses as shown in step 7d, it considers that the corresponding piconet has disappeared from an interference area, and deletes the corresponding entry of the TDMA time offset table in step 7f. After the deletion, the master node enters again into the sleep mode in step 7h.

It is assumed that a new, unrecognizable piconet group announces itself by performing an access operation on an existing piconet. At this initial stage, because the TDMA period schedule information of the piconet that performs an access operation is not known, the control message is not received and a collision may occur. In consideration of this situation an embodiment of the present invention uses the CCA method in the TDMA period.

The TDMA period schedule adjustment in the distributed TDMA method is made possible by sensing the overlapping of the TDMA period schedules between the piconets. The CCA method that is used in accordance with an embodiment of the present invention senses whether the channel is busy from a Received Signal Strength Indicator (RSSI) value, and senses the transmission end time point of an opposite party by continuously performing the CCA for each slot. One slot includes the carrier sensing time and the transmission-reception (Tx-Rx) turnaround times.

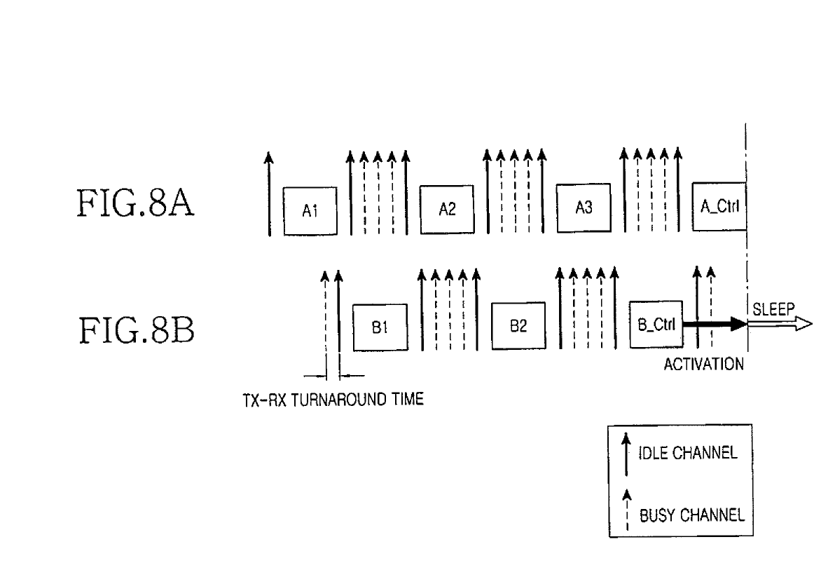

FIGS. 8A and 8B illustrate the TDMA CCA according to an embodiment of the present invention.

Respective upward arrows indicate performing the CCA. Solid-line arrows indicate where it is determined that the channel is idle as the result of performing the CCA, and dotted-line arrows indicate where it is determined that the channel is busy.

Each node performs the CCA once when it first transmits a packet. If it is determined that the channel is in an idle state as the result of performing the CCA, each node transmits a packet. In order to transmit a packet A1, a node A first performs the CCA on an idle state channel. A node B, of another piconet, that initiates an access operation by performing the CCA to transmit a packet, B1. However, because the node A is transmitting the packet A1, the channel is busy. Accordingly, the node B performs again the CCA at the next slot, senses that the channel is in an idle state, and transmits the packet B1.

In order to sense a carrier, a transceiver should be in an Rx state, and in order to transmit a packet, it should be shifted to a Tx state. In this case, a time difference exists between Tx-Rx turnaround times. At this moment, the node A may sense that the channel is in an idle state. In consideration of this situation, in accordance with an embodiment of the present invention the CCA determines the channel is idle twice before successive packet transmission is permitted.

The node A confirms that the channel is busy as a result of twice performing the CCA, and performs the CCA for each slot to wait for an idle state of the channel. Because the transmission is delayed, a packet A2 to be transmitted by the node A is not considered a successive packet, but instead becomes a newly transmitted packet. In this case, packet transmission becomes possible if the channel is in an idle state after only one CCA iteration.

By using the above-described method, the packets can be transmitted without collision in a manner that interleaves the traffic originating from both nodes. Collisions that should normally occur due to the overlapping of the TDMA schedules are avoided.

Using the super frame structure according to an embodiment of the present invention, the control message is transmitted in a TDMA mode at the end of the TDMA period. If different piconets perform access operations, both the piconets should receive the control message in order to make the schedule adjustment in the distributed TDMA method possible. In this situation, the CCA is performed twice after the last packet transmission in the TDMA period.

The control message reception by the nodes A and B is performed as follows and as illustrated in FIG. 7.

In order to transmit the control message “A_Ctrl” after the transmission of a data packet, the node A remains in an active state. In the active state, node A is free to receive the control message “B_Ctrl” transmitted from the node B. However, once the node B transmits all of its TDMA packets and enters into a sleep state, the node B cannot receive the control message from node A. Accordingly, the node B performs the CCA twice after transmitting all the TDMA packets, and if the channel is in an idle state in both cases, the node B returns to the sleep state.

The node B performs the CCA twice after its TDMA packets are all transmitted to provide time for receiving the control message A_Ctrl. Specifically, the node B can receive the control message A_Ctrl transmitted from the node A when the result of performing the first CCA corresponds to the idle state, but the result of performing the second CCA corresponds to the busy state, and in this period, the node B is in an Rx state. After the completion of the transmission of both nodes, the node B re-enters into the sleep mode.

Although certain embodiments of the present inventions have been described, it will be apparent that various modifications can be made without departing from the scope of the invention. The present invention is clearly applicable to other similar MAC protocols in the form in which a contention period and a scheduled period coexist, such as but not limited to a distributed TDMA

As described above, because the energy efficiency of a master node is increased through an on/off scheduling of a piconet master node, energy consumption is minimized, and thus the network lifespan is maximized. Collisions due to the access attempts of an unrecognizable piconet group are prevented through the TDMA CCA, and an efficient coordination between piconets is achievable.

While the present invention has been shown and described with reference to certain embodiments thereof, it will be understood by those skilled in the art that various changes in form and details may be made therein without departing from the spirit and scope of the invention as defined by the appended claims. Accordingly, the scope of the present invention should not be limited to the above-described embodiments, but should be defined by the appended claims and their equivalents.

What is claimed is:

1. A frame structure for piconet master node on/off scheduling, comprising:
a schedule-based data period;
at least one contention-based active period;
a schedule-based schedule notification message period directly following the at least one contention-based active period; and
an inactive sleep mode period positioned before the schedule-based data period, before or after the contention-based active period, or after the schedule-based schedule notification message period.

2. The frame structure of claim 1, wherein the schedule-based period includes a Time Division Multiple Access (TDMA) period, and the contention-based period includes a Carrier Sense Multiple Access (CSMA) period.

3. A method of transmitting a control message in a current super frame by a piconet master node, the method comprising the steps of:
a) determining whether a current channel is busy or idle;
b) if the current channel is idle, confirming that the current channel remains idle for a predetermined number of times, and transmitting the control message, when the current channel remains idle for the predetermined number of times; and
c) if the current channel is busy or if the current channel does not remain idle for the predetermined number of times, returning to step a).

4. The method of claim 3, wherein the predetermined number of times is two.

5. The method of claim 3, further comprising entering into a sleep mode, after transmitting the control message.

6. The method of claim 3, further comprising: receiving a control message of an opposite party by determining whether the current channel is busy for a predetermined number of times after the transmission of a control message.

7. A method for scheduling an on/off mode for a piconet master node, the method comprising the steps of
waiting a predetermined time for reception of a control message;
updating a Time Division Multiple Access (TDMA) time offset table, if the control message is received within the predetermined time; and
deleting a corresponding entry of the TDMA time offset table, if the control message is not received within the predetermined time.

8. The method of claim 7, wherein waiting for the reception of the control message starts after data transmission in a schedule-based period of a neighboring piconet is completed.

9. The method of claim 7, further comprising entering into a sleep mode after performing the step of deleting the entry.

10. The method of claim 7, wherein the time offset table includes a schedule-based time offset table.

11. The method of claim 8, wherein the schedule-based period is a TDMA period.
